(19) United States
(12) Patent Application Publication
(10) Pub. No.: US 2010/0259885 A1
(43) Pub. Date: Oct. 14, 2010

(54) HARD DISK DRIVE HOLDER

(75) Inventors: LEI ZHENG, Shenzhen City (CN); ZHEN-XING YE, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., Ltd., Shenzhen City (CN); HON HAI PRECISION INDUSTRY CO., LTD., Tu-Cheng (TW)

(21) Appl. No.: 12/496,650

(22) Filed: Jul. 2, 2009

(30) Foreign Application Priority Data
Apr. 10, 2009 (CN) 200910301464.5

(51) Int. Cl. G06F 1/16

(52) U.S. Cl. 361/679.36

(57) ABSTRACT

A holder for mounting a hard disk drive includes a main body, and two mounting bodies. The main body includes a panel, and two absorbing arms extending from opposite ends of the panel. The absorbing arms are made of dampening material. The mounting bodies are attached to the absorbing arms respectively, and are operable to fix the hard disk drive therebetween.

### BACKGROUND

1. Technical Field

The disclosure relates to a holder for mounting a hard disk drive.

2. Description of Related Art

A hard disk drive in a computer is mounted to a hard disk drive holder. When the computer works, the hard disk drive will vibrate in the holder, thereby generating noise and possibly reduce the service life of the hard disk drive. The holder is commonly made of metal, which is not good for absorbing vibrations. Therefore, a number of dampeners, such as springs or rubber pads, are mounted to the holder for helping absorb/dampen vibration. However, the cost of absorbing vibrations utilizing dampeners is often too high.

### BRIEF DESCRIPTION OF THE DRAWINGS

FIG. 1 is an assembled, isometric view of an embodiment of a holder together with a hard disk drive.

FIG. 2 is an exploded view of the holder and the hard disk drive of FIG. 1.

FIG. 3 is an inverted view of FIG. 2.

FIG. 4 is an assembled, isometric view of the holder of FIG. 1.

### DETAILED DESCRIPTION

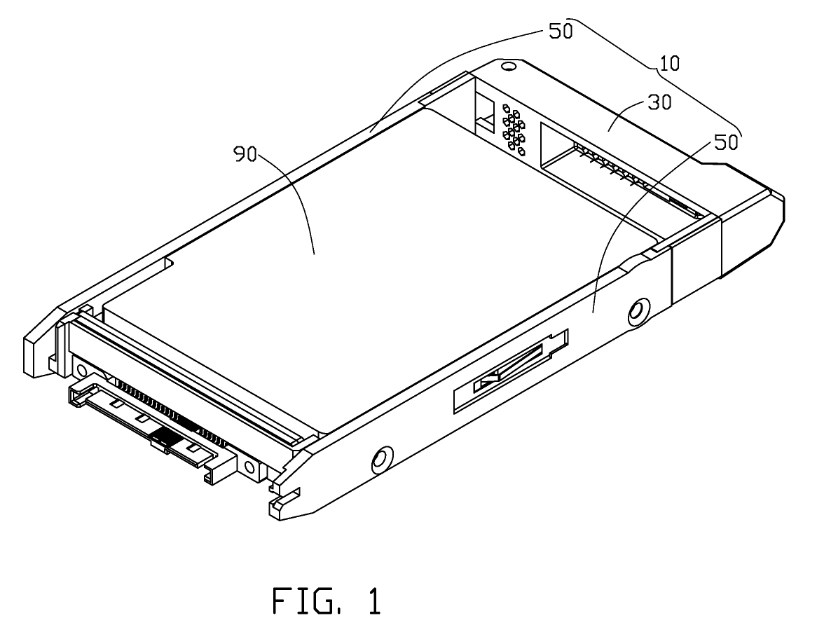

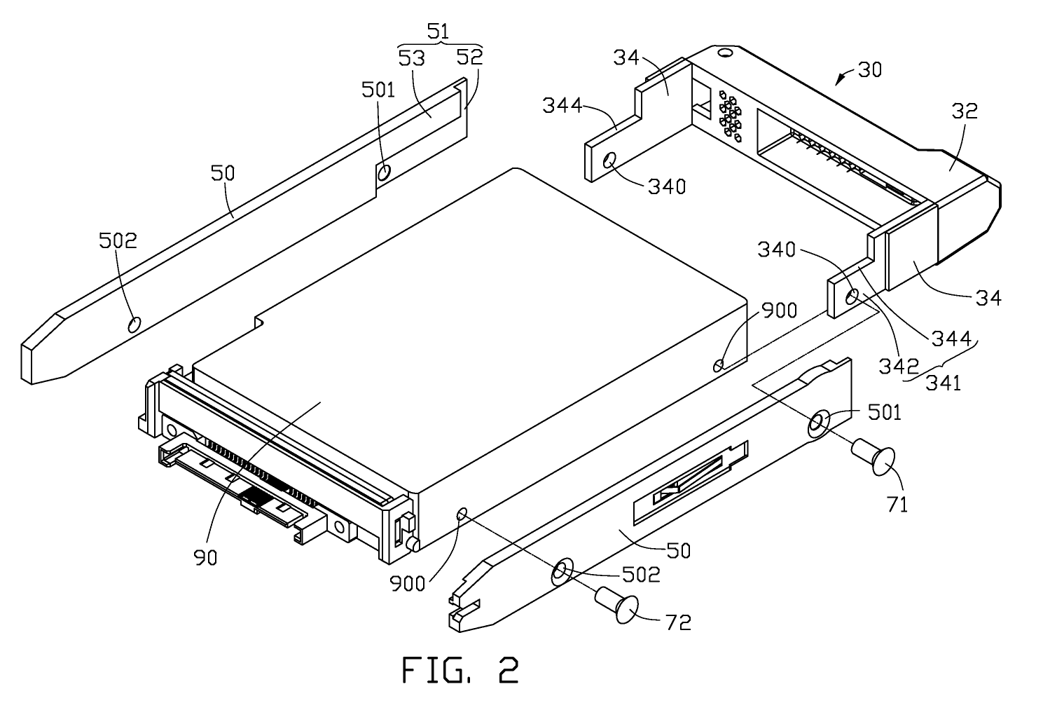

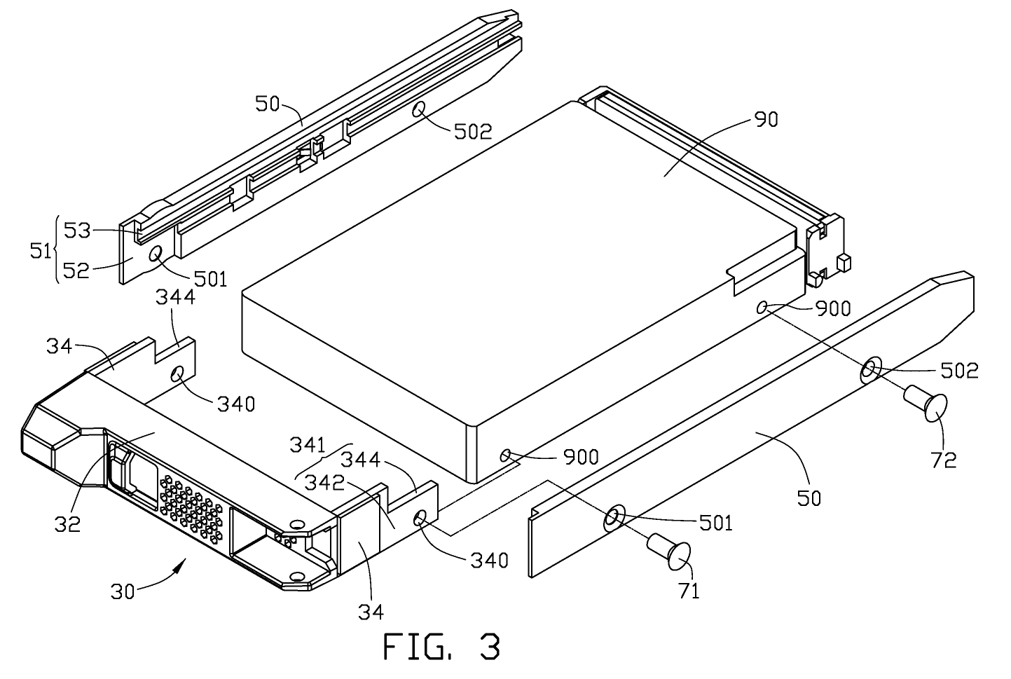

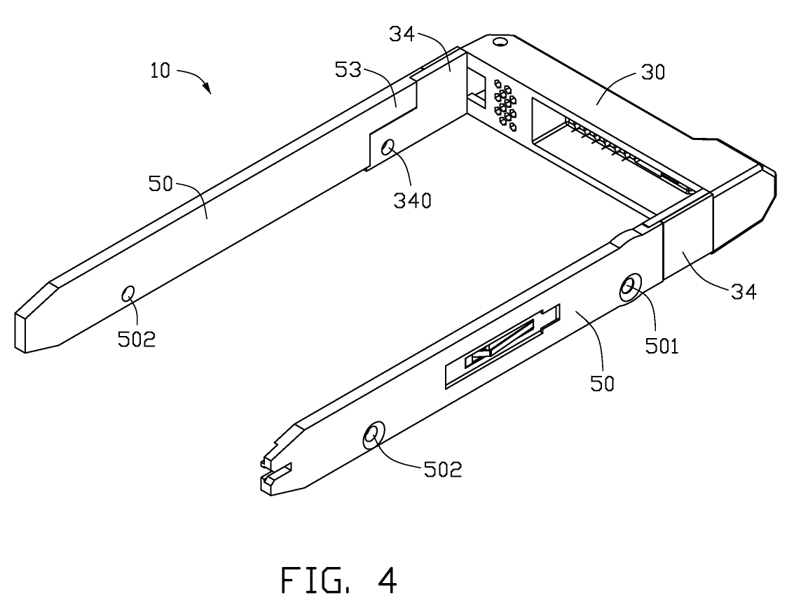

Referring to FIGS. 1 to 4, an embodiment of a holder 10 is used for mounting a hard disk drive 90. Each of opposite sides of the hard disk drive 90 defines two mounting holes 900. The holder 10 includes a main body 30, and two mounting bodies 50.

The main body 30 includes a panel 32, and two absorbing arms 34 perpendicularly extending from opposite ends of the panel 32. A first depressed portion 342 is formed on an outer side of a distal end of each absorbing arm 34. A notch 344 is defined in the first depressed portion 342. The first depressed portion 342 and the corresponding notch 344 combine to make the distal end of each absorbing arm 34 be a first lapping portion 341. Each first depressed portion 342 defines a first through hole 340. The material of the absorbing arms 34 of the main body 30 is made of dampening material, and the remainder of the main body 30 may also be made of dampening material. In one embodiment, rubber-like plastic is selected as the dampening material.

The mounting bodies 50 are used to fix the hard disk drive 90. An L-shaped second depressed portion 52 is formed on an inner side of an end of each mounting body 50. The remaining portion of the corresponding end of each mounting body 50 forms a block 53 which is surrounded by the second depressed portion 52. The second depressed portion 52 and the corresponding block 53 combine to make the corresponding end of each mounting body 50 be a second lapping portion 51. Each second depressed portion 52 defines a second through hole 501. The remaining portion of each mounting body 50 except the second lapping portion 51, defines a third through hole 502. The material of each mounting body 50 is metal.

In assembly, an end of the hard disk drive 90 is received among the absorbing arms 34 of the main body 30. The second lapping portions 51 of the mounting bodies 50 are lapped on the first lapping portions 341 of the main body 30, wherein, each second depressed portion 52 abuts against the corresponding first depressed portion 342, and each block 53 is received in the corresponding notch 344. A fixing element 71, such as a screw, is extended through the second through hole 501 of corresponding mounting body 50, the first through hole 340 of the corresponding absorbing arm 34, and engaged in a corresponding mounting hole 900 of the hard disk drive 90. A fixing element 72, such as a screw, is extended through the third through hole 502 of corresponding mounting body 50 and engaged in a corresponding mounting hole 900 of the hard disk drive 90.

Accordingly, the dampening material, such as rubber-like plastic utilized in the holder 10, absorbs vibration to protect the hard disk drive 90. Therefore, low cost dampening in a holder can be achieved.

It is to be understood, however, that even though numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A holder for mounting a hard disk drive, comprising:
a main body to be attached to an end of the hard disk drive, the main body comprising a panel, and two absorbing arms extending from opposite ends of the panel, wherein the absorbing arms are made of dampening material; and
two mounting bodies attached to the absorbing arms respectively and operable to be fix the hard disk drive therebetween.

2. The holder of claim 1, wherein the dampening material is rubber-like plastic.

3. The holder of claim 1, wherein each of the absorbing arms comprises a first lapping portion formed at a distal end of the absorbing arm, each of the mounting bodies comprises a second lapping portion formed at an end of the mounting body, each second lapping portion is lapped on the corresponding first lapping portion.

4. The holder of claim 3, wherein each first lapping portion comprises a first depressed portion formed on an outer side of the distal end of the corresponding absorbing arm, a notch is defined in each first depressed portion, each second lapping portion comprises an L-shaped second depressed portion and a block, the second depressed portion is formed on an inner side of the corresponding end of each mounting body, each block is surrounded by the corresponding second depressed portion, wherein each second depressed portion abuts against the corresponding first depressed portion, and each block is received in the corresponding notch.

5. The holder of claim 4, wherein each first depressed portion defines a first through hole, each second depressed portion defines a second through hole, each first through hole and the corresponding second through hole is operable of being inserted through by a screw.

6. The holder of claim 5, wherein the remaining portion of each of the mounting bodies except the second lapping portion, defines a third through hole.

7. The holder of claim 6, wherein each of the mounting bodies is made of metal.
